(19) United States
(12) Patent Application Publication
(10) Pub. No.: US 2010/0158633 A1
(43) Pub. Date: Jun. 24, 2010

(54) FIXING SYSTEM FOR CIRCUIT BOARD

(75) Inventor: HSIEH-TING HUANG, Miao-Li County (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP., Miao-Li County (TW)

(21) Appl. No.: 12/635,834

(22) Filed: Dec. 11, 2009

(30) Foreign Application Priority Data
Dec. 19, 2008 (CN) 200810306408.6

(51) Int. Cl. F16B 13/04

(52) U.S. Cl. 411/25

(57) ABSTRACT

An exemplary fixing system includes a plate portion and four fastening units latched on the plate portion. The plate portion defines four fixing holes having a polygonal shape. Each fastening unit includes a fixing portion having a base and a deformable portion, and an engaging portion. At least a part of the base has a polygonal shape matching the shape of the fixing hole. A slot is defined in the deformable portion or the deformable portion in cooperation with the base. A side edge of the plate portion which bounds the fixing hole is latchingly received in the slot. The deformable portion is deformable to allow said at least a part of the base to pass through the fixing hole in assembly of the fixing system until the deformable portion rebounds and the side edge of the plate portion is latched in the slot.

### BACKGROUND

1. Technical Field

The present disclosure generally relates to fixing systems for circuit boards.

2. Description of Related Art

Electronic devices often include circuit boards. A circuit board is usually fixed to a housing of the electronic device via a fixing system. In a frequently used fixing system, the circuit board is connected to a shielding plate. The shielding plate is riveted with a plurality of studs, and a plurality of screws extend through the circuit board and are engaged in the studs.

However, the studs must be riveted onto the shielding plate. This process requires special equipment and considerable man-hours, thus increasing both manufacturing time and costs.

Therefore, a fixing system that can overcome the described limitations is desired.

### BRIEF DESCRIPTION OF THE DRAWINGS

The components in the drawings are not necessarily drawn to scale, the emphasis instead being placed upon clearly illustrating the principles of the present invention. Moreover, in the drawings, like reference numerals designate corresponding parts throughout the several views.

FIG. 1 is an exploded, isometric view of a first embodiment of a fixing system together with a circuit board, the fixing system including a plate, a plurality of fastening units, and a plurality of fasteners.

FIG. 2 is an assembled view of the fixing system of FIG. 1 fixing the circuit board.

FIG. 3 is an enlarged, isometric view of one of the fastening units of the fixing system of FIG. 1.

FIG. 4 is an isometric view of a fastening unit used in a second embodiment of a fixing system.

### DETAILED DESCRIPTION

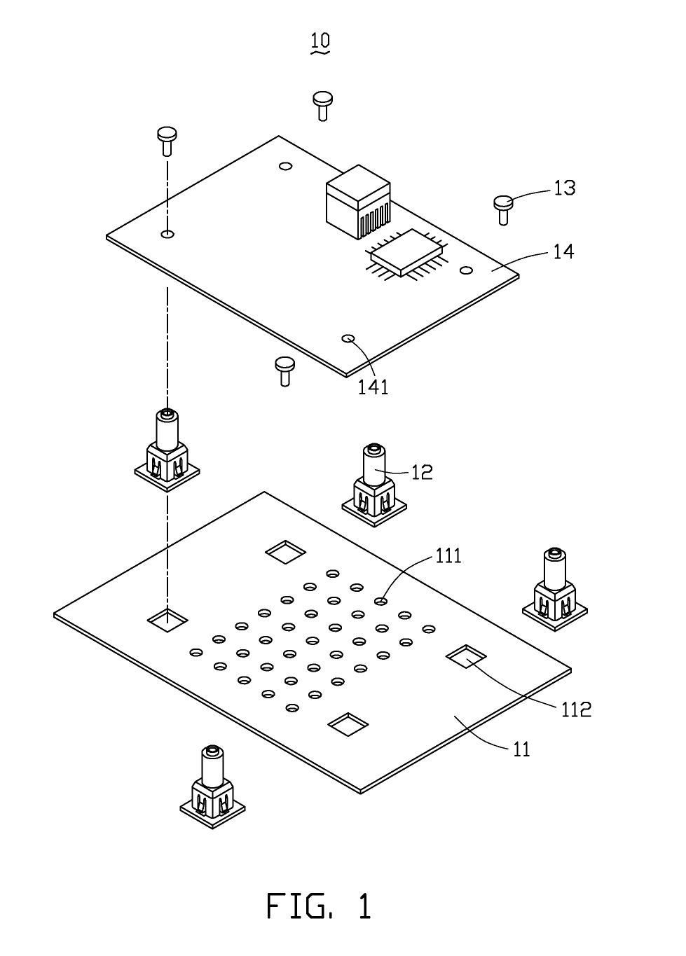

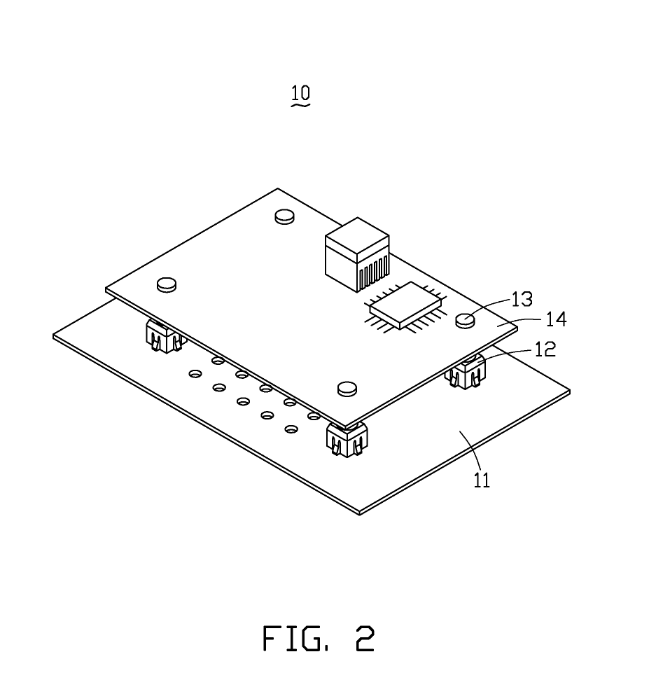

Referring to FIG. 1 and FIG. 2, a first embodiment of a fixing system 10 is shown. The fixing system 10 includes a plate portion 11, a plurality of fastening units 12, and a plurality of fasteners 13 corresponding to the fastening units 12. The fastening units 12 are latched on the plate portion 11, and the fasteners 13 engage with the fastening units 12 to fix a circuit board 14 on the plate portion 11. In the illustrated embodiments, there are four fastening units 12 and four fasteners 13.

The plate portion 11 is a thin sheet made of iron, plastic or other material. In the illustrated embodiment, the plate portion 11 is applied in a liquid crystal display device for shielding electromagnetism, and is thus a metallic plate, such as an iron plate. The plate portion 11 defines a plurality of ventilation holes 111 and at least one fixing hole 112. In the illustrated embodiment, there are four fixing holes 112 corresponding to the number of fastening units 12. In order to shield electromagnetism, a diameter of each ventilation hole 111 is less than 5 mm. Each fixing hole 112 is polygonal. Preferably, each fixing hole 112 is a regular polygon; for example, a regular triangle, square, or hexagon. In the illustrated embodiment, the fixing holes 112 are square, but alternatively the fixing holes 112 may have other shapes.

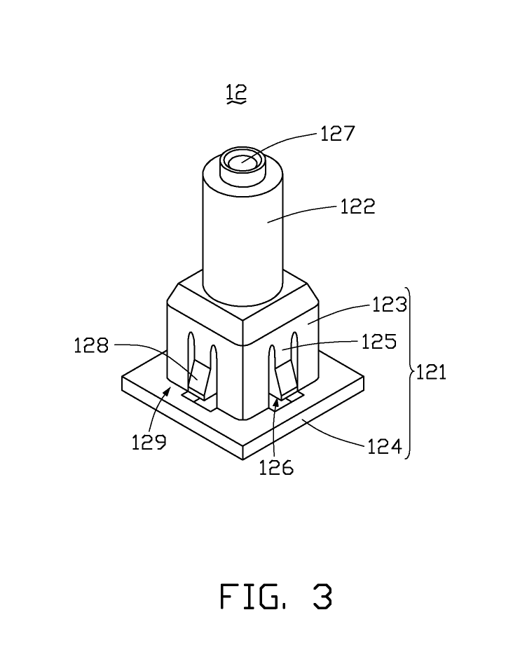

Referring also to FIG. 3, each fastening unit 12 includes a fixing portion 121 and an engaging portion 122 connected to the fixing portion 121. The fixing portion 121 includes a base 123, a resisting plate 124, and a plurality of latching hooks 125. The base 123 corresponds in cross-section to the shape of one fixing hole 112, to prevent the fastening unit 12 from rotating relative to the plate portion 11 when the fastening unit 12 is latched to the plate portion 11. The engaging portion 122 and the resisting plate 124 are formed at opposite top and bottom ends of the base 123.

The latching hooks 125 are formed on sidewalls of the base 123 and protrude out from the sidewalls. The latching hooks 125 are elastic, and thus deformable. In the illustrated embodiment, each latching hook 125 is wedge-shaped, and includes an inclined surface 128. The inclined surface 128 faces a direction generally away from the resisting plate 124. The latching hook 125 includes a first resisting surface 126 at a free end thereof, the first resisting surface 126 facing the resisting plate 124. A bottommost portion of the latching hook 125 has a uniform width as measured along a radial direction from a center axis (not shown) of the fastening unit 12. A width of the latching hook 125 at the inclined surface 128 as measured along the radial direction from the center axis of the fastening unit 12 progressively decreases in a direction away from the first resisting surface 126. The resisting plate 124 includes a second resisting surface 129 facing the first resisting surface 126. A slot (not labeled) is defined between the first and second resisting surfaces 126, 129, for receiving a side edge of the plate portion 11 which bounds the corresponding fixing hole 112. A distance between the first and second resisting surfaces 126, 129, i.e., a vertical width of the slot, is substantially the same as or slightly larger than a thickness of the plate portion 11.

The engaging portion 122 of each fastening unit 12 defines an engaging hole 127. The engaging hole 127 may be a threaded hole or a hole bounded by a smooth cylindrical wall. In the illustrated embodiment, each fastener 13 is a screw for engaging in the engaging hole 127. When the engaging hole 127 is bounded by a smooth cylindrical wall, the fastener 13 is a self-tapping screw.

The circuit board 14 defines at least one mounting hole 141. In the illustrated embodiment, there are four mounting holes 141 corresponding to the fixing holes 112.

In assembly of the fixing system 10, the engaging portion 122 and the base 123 of each fastening unit 12 are extended through a corresponding one of the fixing holes 112 of the plate portion 11. As the base 123 passes through the fixing hole 112, the latching hooks 125 are squeezed by the side edges of the plate portion 11 which bound the fixing hole 112. The latching hooks 125 deform, thus allowing the base 123 to pass through the fixing hole 112. The resisting plate 124, being larger than the fixing hole 112, cannot pass through the fixing hole 112. After passing through the fixing hole 112, the latching hooks 125 rebound to a relaxed state. The plate portion 11 is held between the first resisting surfaces 126 of the latching hooks 125 and the second resisting surface 129 of the resisting plate 124. The engagement of the base 123 in the fixing hole 112 with a matching shape prevents the fastening unit 12 from rotating relative to the plate portion 11. The fastening unit 12 is thus fixed to the plate portion 11.

To mount the circuit board 14 to the plate portion 11, the circuit board 14 is placed on the fastening units 12, with the engaging portions 122 aligned with the mounting holes 141. In one embodiment, annular upper steps (not labeled) of the engaging portions 122 support a bottom of the circuit board 14, and annular reduced topmost parts of the engaging portions 122 which are above the steps are received in the mounting holes 141. The fasteners 13 are passed through the mounting holes 141 and engaged in the engaging holes 127, and circuit board 14 is thus fixed to the plate portion 11.

In the fixing system 10, the fastening units 12 are fixed to the plate portion 11 by way of part of each fastening unit 12 engaging in the corresponding fixing hole 112. The fixing system 10 can thus be implemented in a single movement of the plate portion 11 onto the fastening units 12. As the base 123 of each fastening unit 12 passes through the fixing hole 112, the inclined surfaces 128 are elastically deformed inwardly and allow the base 123 to move through. Thus implementation of the fixing system 10 is convenient, with assembly of the circuit board 14 to the plate portion 11 quick and inexpensive.

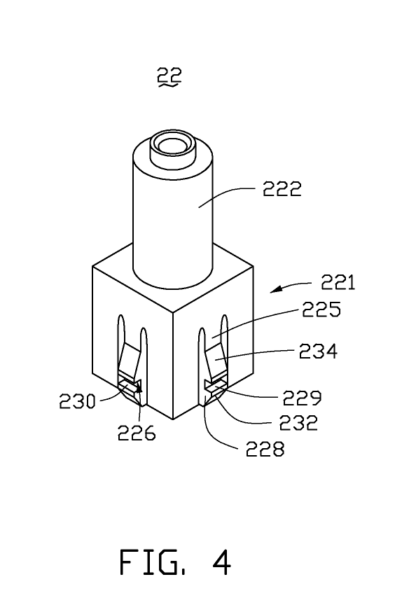

Referring to FIG. 4, a fastening unit 22 used in a second embodiment of a fixing system differs from the fastening unit 12 of the first embodiment as follows. A fixing portion 221 of the fastening unit 22 includes a plurality of latching hooks 225, each having a protrusion 228; and there is no resisting plate. The protrusion 228 defines a slot 229, which is bounded by a first (top) resisting surface 226 and a second (bottom) resisting surface 230. The protrusion 228 includes two inclined surfaces 232, 234 formed at opposite sides of the slot 229. The fastening unit 22 is fixed to the plate portion 11 by way of each of four side edges of the plate portion 11 surrounding the corresponding fixing hole 112 being held in a corresponding one of the slots 229, with opposite top and bottom sides of the side edge of the plate portion 11 resisting the first resisting surface 226 and the second resisting surface 230. Unlike with the fixing system 10 with the fastening units 12, there are two different ways in which each fastening unit 22 can be fixed to the plate portion 11. The first way involves an engaging portion 222 of the fastening unit 22 being firstly inserted through the corresponding fixing hole 112 of the plate portion 11. The second way involves the fixing portion 221 being firstly inserted through the corresponding fixing hole 112. Thereby, the fastening units 22 provide the fixing system with simplified and flexible assembly. Whichever of the two ways is implemented, as the fixing portion 221 of each fastening unit 22 passes through the fixing hole 112, the inclined surfaces 234 (or the inclined surfaces 232, as the case may be) are squeezed by the side edges of the plate portion 11 which bound the fixing hole 112, and the latching hooks 225 elastically deformed inwardly and allow the fixing portion 221 to move through. Thus implementation of the fixing system is convenient, with assembly of the circuit board 14 to the plate portion 11 quick and inexpensive.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A fixing system, comprising:
a plate portion defining at least one fixing hole having a polygonal shape; and
at least one fastening unit latched on the plate portion, the at least one fastening unit comprising a fixing portion and an engaging portion, the fixing portion comprising a base and a deformable portion, at least a part of the base having a polygonal shape matching the polygonal shape of the at least one fixing hole, wherein a slot is defined in the deformable portion or the deformable portion in cooperation with the base; and a side edge of the plate portion which bounds the at least one fixing hole is latchingly received in the slot;
wherein the polygonal shapes of said at least a part of the base and the at least one fixing hole prevent the at least one fastening unit from rotating relative to the plate portion; the deformable portion is deformable to allow said at least a part of the base to pass through the at least one fixing hole in assembly of the fixing system until the deformable portion rebounds and the side edge of the plate portion is latched in the slot, thus fixing the fastening unit to the plate portion.

2. The fixing system of claim 1, wherein a cross-section of said at least a part of the base and the shape of the at least one fixing hole are regular polygons.

3. The fixing system of claim 1, wherein the base of the at least one fastening unit further comprises a resisting plate, which is located at an end of the base farthest from the engaging portion, and the deformable portion comprises a latching hook formed on the base; and the latching hook in cooperation with the resisting plate define the slot.

4. The fixing system of claim 3, wherein the latching hook is wedge-shaped and comprises an inclined surface facing in a direction generally away from the resisting plate.

5. The fixing system of claim 1, wherein the deformable portion of the at least one fastening unit comprises a latching hook formed on the base, the latching hook alone defines the slot, the latching hook comprises a protrusion, and at least a part of the slot is defined in the protrusion.

6. The fixing system of claim 5, wherein the protrusion of the at least one fastening unit forms two inclined surfaces at opposite sides of the slot.

7. The fixing system of claim 1, further comprising at least one fastener, wherein the engaging portion of the at least one fastening unit defines an engaging hole for engagingly receiving with the at least one fastener.

8. The fixing system of claim 7, wherein the at least one fastener is at least one screw, and the engaging hole of the at least one fastening unit is a threaded hole.

9. The fixing system of claim 7, wherein the at least one fastener is at least one self-tapping screw.

10. A fixing system, comprising:
a plate portion defining at least one fixing hole; and
at least one fastening unit extending through the at least one fixing hole and fixed to the plate portion, the at least one fixing hole and at least part of the at least one fastening unit complementarily shaped such that the at least one fastening unit is non-rotatable relative to the plate portion, the at least one fastening unit comprising a first resisting surface and a second resisting surface, and further comprising a deformable latching hook;
wherein when the at least one fastening unit is fixed to the plate portion, the latching hook firstly deforms to allow the at least one fastening unit to move through the at least one fixing hole and then rebounds so that a part of the plate portion bounding the at least one fixing hole is sandwiched and held between the first resisting surface and the second resisting surface.

11. The fixing system of claim 10, wherein the at least one fastening unit comprises a base, and the base has a cross-section corresponding to the shape of the at least one fixing hole to prevent the at least one fastening unit from rotating relative to the plate portion.

12. The fixing system of claim 10, wherein the at least one fastening unit comprises a fixing portion and an engaging portion connected to the fixing portion, and the latching hook is formed on the fixing portion.

13. The fixing system of claim 12, wherein the fixing portion of the at least one fastening unit comprises a base and a resisting plate; the resisting plate is formed at an end of the base farthest from the engaging portion; the first resisting surface is defined on the latching hook, and the second resisting surface is defined on the resisting plate.

14. The fixing system of claim 13, wherein the at least one latching hook is wedge-shaped and comprises an inclined surface facing in a direction generally away from the resisting plate.

15. The fixing system of claim 12, wherein the fixing portion of the at least one fastening unit comprises a base; the latching hook is formed on the base and comprises a protrusion, and at least a part of the first resisting surface and at least a part of the second resisting surface are defined on the protrusion.

16. The fixing system of claim 15, wherein the first resisting surface and the second resisting surface of the at least one fastening unit are separated by a slot defined in the protrusion, and the protrusion forms two inclined surfaces at opposite sides of the slot.

17. The fixing system of claim 12, further comprising at least one fastener, wherein the engaging portion of the at least one fastening unit defines an engaging hole for engagingly receiving the at least one fastener.

18. A fixing system for a circuit board, the fixing system comprising:
a plate portion defining at least one fixing hole with a keyed configuration; and
at least one fastening unit fixed to the plate portion, the at least one fastening unit comprising at least one deformable latching hook and defining a slot engagingly receiving part of the plate portion, part of the at least one fastening unit having a keyed configuration corresponding to the keyed configuration of the at least one fixing hole;
wherein when part of the at least one fastening unit is extended through the at least one fixing hole in assembly of the fixing system, the at least one deformable latching hook firstly deforms to allow interferential passage of said part of the at least one fastening unit through the at least one fixing hole and then rebounds thereby providing a snap-fit connection between the at least one fastening unit and the plate portion, with the keyed configurations of said part of the at least one fastening unit and the at least one fixing hole preventing rotation of the at least one fastening unit in the at least one fixing hole.

19. The fixing system of claim 18, wherein the at least one fastening unit further comprises an inclined surface generally adjacent to the slot to facilitate the interferential passage of said part of the at least one fastening unit through the at least one fixing hole.
